(19) United States
(12) Patent Application Publication
(10) Pub. No.: US 2025/0132396 A1
(43) Pub. Date: Apr. 24, 2025

(54) ALL SOLID STATE SECONDARY BATTERY AND METHOD OF MANUFACTURING THE SAME

(71) Applicants: HYUNDAI MOTOR COMPANY, Seoul (KR); Kia Corporation, Seoul (KR)

(72) Inventors: Tae Young KWON, Daegu (KR); Jong Hwan CHOI, Hwaseong-si (KR); Yong Jun LEE, Incheon (KR); Ju Min KIM, Hwaseong-si (KR); Yong Hun LEE, Hwaseong-si (KR)

(21) Appl. No.: 18/665,963

(22) Filed: May 16, 2024

(30) Foreign Application Priority Data
Oct. 18, 2023 (KR) 10-2023-0139656

(51) Int. Cl. H01M 10/0585; B32B 7/027; B32B 27/08; B32B 27/30; C08J 5/12; H01M 10/42

(52) U.S. Cl. CPC H01M 10/0585; B32B 7/027; B32B 27/08; B32B 27/302; B32B 27/306; C08J 5/121; H01M 10/4235; B32B 2250/03; B32B 2250/246; B32B 2250/40; B32B 2307/30; B32B 2307/7376; B32B 2457/10; C08J 2323/08; C08J 2325/06; H01M 2300/0065

(57) ABSTRACT

An all-solid-state secondary battery includes a cell stack having a stack structure, and a protective member including a first thermoplastic resin layer, a second thermoplastic resin layer, and a third thermoplastic resin layer sequentially stacked, and being disposed on a peripheral portion, in which the cathode layer is not disposed, of the solid-state electrolyte layers, while being interposed between the two solid-state electrolyte layers disposed to be adjacent to each other such that the cathode layer is interposed between the two solid-state electrolyte layers. A glass transition temperature of the first thermoplastic resin layer and a glass transition temperature of the third thermoplastic resin layer are lower than a glass transition temperature of the second thermoplastic resin layer.

### CROSS-REFERENCE TO RELATED APPLICATION

This application claims the benefit of priority to Korean Patent Application No. 10-2023-0139656, filed in the Korean Intellectual Property Office on Oct. 18, 2023, the entire contents of which are incorporated herein by reference.

### TECHNICAL FIELD

The present disclosure relates to an all-solid-state secondary battery and a method for manufacturing the same.

### BACKGROUND

In general, an all-solid-state secondary battery may be provided in the form of a unit cell including an anode layer, a cathode layer, and a solid-state electrolyte layer interposed between the anode layer and the cathode layer. For example, the all-solid-state secondary battery may include a cell stack including a stack structure of a plurality of unit cells.

To form the above-described cell stack, a warm pressing process has been commonly used to stack the plurality of unit cells and press the final structure in a stack direction. In this case, the warm pressing (e.g., warm isostatic pressing) process, which is a process to press the stacked plurality of unit cells in the stack direction at a higher temperature (e.g., 90° C.), may be performed to bond the solid-state electrolyte layer to the anode layer and/or cathode layer through sintering.

In some cases, when the above-described warm pressing process is performed, the solid-state electrolyte layer may be cracked due to the stress difference resulting from the difference in area (e.g., the cathode layer has a smaller area) between the anode layer, the cathode layer and/or the solid-state electrolyte layer included in the unit cell. Accordingly, the reliability for the all-solid-state secondary battery may be degraded.

### SUMMARY

The present disclosure has been made to solve the above-mentioned problems occurring in the prior art while advantages achieved by the prior art are maintained intact.

An aspect of the present disclosure provides an all-solid-state secondary battery having improved reliability and a method for manufacturing an all-solid-state secondary battery having improved reliability.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an all-solid-state secondary battery may include a cell stack having a stack structure, which is formed by stacking a plurality of unit cells, each unit cell including an anode layer, a pair of solid-state electrolyte layers interposing the anode layer between the solid-state electrolyte layers, and a cathode layer which is smaller than the anode layer in an area facing one solid-state electrolyte layer, provided in opposition to the anode layer such that the one solid-state electrolyte layer from among the solid-state electrolyte layers is interposed between the anode layer and the cathode layer, and a protective member including a first thermoplastic resin layer, a second thermoplastic resin layer, and a third thermoplastic resin layer sequentially stacked, and being disposed on a peripheral portion, in which the cathode layer is not disposed, of the solid-state electrolyte layers, while being interposed between the two solid-state electrolyte layers disposed to be adjacent to each other such that the cathode layer is interposed between the two solid-state electrolyte layers. A glass transition temperature of the first thermoplastic resin layer and a glass transition temperature of the third thermoplastic resin layer are lower than a glass transition temperature of the second thermoplastic resin layer.

According to another aspect of the present disclosure, a method for manufacturing an all-solid-state secondary battery may include forming a preliminary cell stack formed by stacking a plurality of unit cells. Each unit cell may include an anode layer, a pair of solid-state electrolyte layers interposing the anode layer between the solid-state electrolyte layers, and a cathode layer provided in opposition to the anode layer such that one solid-state electrolyte layer from among the solid-state electrolyte layers is interposed between the anode layer and the cathode layer, and smaller than the anode layer in an area facing the one solid-state electrolyte layer, and a protective member may be disposed in the unit cell, the protective member including a first thermoplastic resin layer, a second thermoplastic resin layer, and a third thermoplastic resin layer sequentially stacked in a peripheral portion, in which the cathode layer is not disposed, of one solid-state electrolyte layer, and on a side surface of the cathode layer, and forming a cell stack by performing a warm pressing process for the preliminary cell stack, in a stack direction in which the plurality of unit cells are stacked, and a glass transition temperature of the first thermoplastic resin layer and a glass transition temperature of the third thermoplastic resin layer may be lower than a glass transition temperature of the second thermoplastic resin layer.

### BRIEF DESCRIPTION OF THE DRAWINGS

The above and other objects, features and advantages of the present disclosure will be more apparent from the following detailed description taken in conjunction with the accompanying drawings:

FIG. 1 is a view illustrating an example all-solid-state secondary battery, according to an implementation of the present disclosure;

FIG. 2 is an enlarged view illustrating region A of FIG. 1;

FIG. 3 is a view illustrating an example method for manufacturing an all-solid-state secondary battery, according to an implementation of the present disclosure;

FIG. 4 illustrates an enlarged view of region B and region B′ of FIG. 3;

FIG. 5 is an optical microscope (OM) image of an example all-solid-state secondary battery manufactured according to an implementation of the present disclosure;

FIG. 6 is an optical microscope (OM) image of an example all-solid-state secondary battery manufactured according to a comparative example of the present disclosure;

FIG. 7 is a graph illustrating the evaluation for a capacity retention characteristic all-solid-state secondary battery manufactured according to example implementations of the present disclosure; and

FIG. 8 is a graph illustrating the evaluation for an output characteristic of an all-solid-state secondary battery manufactured according to example implementations of the present disclosure.

### DETAILED DESCRIPTION

Hereinafter, an all-solid-state secondary battery and a method for manufacturing the same will be described in detail such that those skilled in the art easily reproduces the present disclosure.

### All-Solid-State Secondary Battery

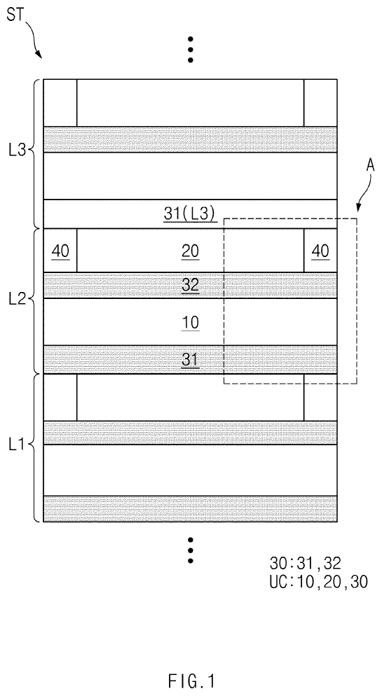

FIG. 1 is a view illustrating an all-solid-state secondary battery, according to an implementation of the present disclosure.

Referring to FIG. 1, according to the present disclosure, the all-solid-state secondary battery may include a cell stack ST having a stack structure in which a plurality of unit cells UC are stacked, and a protective member 40. The unit cell UC may include an anode layer 10, a pair of solid-state electrolyte layers 30, and a cathode layer 20.

While FIG. 1 illustrates a first layer L1, a second layer L2, and a third layer L3 defined by three unit cells UC stacked, for convenience of description, the present disclosure is not limited thereto. For example, the cell stack ST may have a four-layer structure, a five-layer structure, or a stack structure having five or more layers.

The anode layer 10 may include an anode active material layer and/or an anode current collector layer. In this case, the anode active material layer and the anode current collector layer may employ various types of anode active material layers and various types of anode current collector layers, which are well known and generally used for the anode layer 10 of the all-solid-state secondary battery, without limitation.

The anode layer 10 may be interposed between one pair of solid-state electrolyte layers 30. In other words, as illustrated in FIG. 1, the pair of solid-state electrolyte layers 30 may include a solid-state electrolyte layer 31 disposed on a bottom surface of the anode layer 10 and a solid-state electrolyte layer 32 disposed on a top surface of the anode layer 10.

The solid-state electrolyte included in the solid-state electrolyte layer 30 may employ various types of solid electrolytes, which are generally used for the all-solid-state secondary battery, without limitation. For example, a pair of solid-state electrolyte layers 30 may include at least one selected from the group consisting of a polymer solid electrolyte, a sulfide solid electrolyte, and an oxide solid electrolyte.

The cathode layer 20 may include a cathode active material layer and/or a cathode current collector layer. In this case, the cathode active material layer and/or the cathode current collector layer may employ various types of cathode active material layers and various types of cathode current collector layers, which are generally used for the all-solid-state secondary battery and well-known, without limitation.

The cathode layer 20 may be provided in opposition to the anode layer 10 such that the solid-state electrolyte layer 32 is interposed between the cathode layer 20 and the anode layer 10. In this case, the area of the cathode layer 20 facing the solid-state electrolyte layer 32 may be smaller than the area of the anode layer 10 facing the solid-state electrolyte layer 32. This is because the capacitance characteristic of the all-solid-state secondary battery is determined by the cathode layer 20. When the area of the anode layer 10 is used as possible as efficient, the capacitance characteristic of the all-solid-state secondary battery may be improved.

In some cases, as described above, since the areas of the anode layer 10 and the solid-state electrolyte layer 30 are larger than the area of the cathode layer 20, the anode layer 10 and the solid-state electrolyte layer 30 in the stack cell ST may have side surfaces protruding from a side surface of the cathode layer as illustrated in FIG. 1. In this case, when pressure is applied in the stack direction of the unit cell UC, as impact is applied from the outside, the solid-state electrolyte layer 30 may be broken due to the stress difference (e.g., the stress is concentrated on the boundary between a part, which makes contact with the anode layer 10, of the solid-state electrolyte layer 30 and a part, which do not make contact with the anode layer 10, of the solid-state electrolyte layer 30) resulting from the difference in area between the cathode layer 20 and the solid-state electrolyte layer 30.

To prevent the above-described problem, a protective member 40 may be provided on a peripheral portion, which has no the anode layer 10, of solid-state electrolyte layers, while being interposed between two solid-state electrolyte layers adjacent to each other, such that the anode layer 10 is interposed between the solid-state electrolyte layers. For example, as illustrated in FIG. 1, the protective member 40 may be provided between a peripheral portion of the solid-state electrolyte layer 32 L3 and a peripheral portion of the solid-state electrolyte layer 31 L3, between the solid-state electrolyte layer 32 in the unit cell UC disposed in the second layer L2 and the solid-state electrolyte layer 31 (L3) in the unit cell UC disposed in the third layer L3. Accordingly, the protective member 40 may compensate for the step difference defined by the difference in area between the cathode layer 20 and the solid-state electrolyte layer 30.

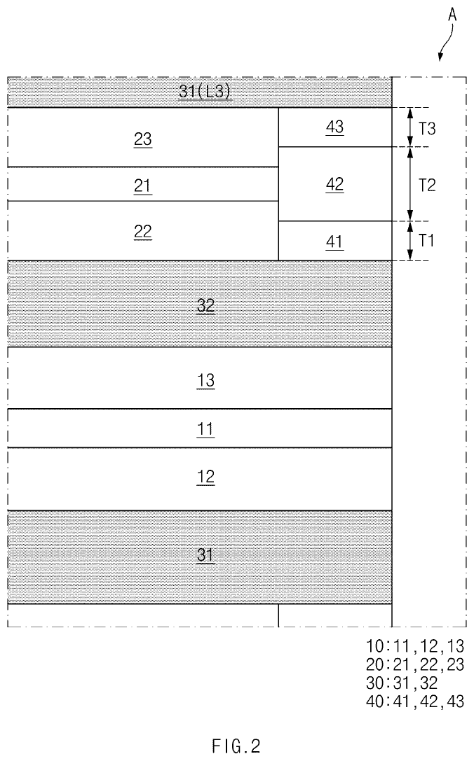

FIG. 2 is an enlarged view illustrating region A of FIG. 1. Hereinafter, the protective member 40 according to the present disclosure will be described in more detail with reference to FIG. 2.

Referring to FIG. 2, the protective member 40 may include a first thermoplastic resin layer 41, a second thermoplastic resin layer 42, and a third thermoplastic resin layer 43 which are sequentially stacked. For example, as illustrated in FIG. 2, the first thermoplastic resin layer 41 may be disposed on the peripheral portion of the solid-state electrolyte layer 32, and the third thermoplastic resin layer 43 may be disposed on the peripheral portion of the solid-state electrolyte layer 31 L3. In this case, the second thermoplastic resin layer 42 may be interposed between the first thermoplastic resin layer 41 and the third thermoplastic resin layer 43. In other words, the second thermoplastic resin layer 42 may space the two solid-state electrolyte layers (e.g., see reference numeral 32 and 31 (L3)) which are disposed to be adjacent to each other, from each other such that the cathode layer 20 is interposed between the solid-state electrolyte layers.

In this case, each of a glass transition temperature of the first thermoplastic resin layer 41 and a glass transition temperature of the third thermoplastic resin layer 43 may be lower than a glass transition temperature of the second thermoplastic resin layer 42, respectively. When the glass transition temperatures of the first to third thermoplastic resin layers 41, 42, and 43 satisfy the above condition, the protective member 40 may have both excellent shock absorption derived from the first and third thermoplastic resin layers 41 and 43 having a lower glass transition temperature and excellent mechanical strength derived from the second thermoplastic resin layer 42 having a higher glass transition temperature.

According to an implementation, the second thermoplastic resin layer 42 may include various types of thermoplastic resin which have a glass transition temperature higher than that of the thermoplastic resin included in the first and third thermoplastic resin layers 41 and 43 and are well known. For example, the second thermoplastic resin layer 42 may include at least one selected from the group consisting of polyvinyl chloride, polystyrene, polymethyl methacrylate, and acrylonitrile butadiene styrene.

According to an implementation, the first and third thermoplastic resin layers 41 and 43 may each include various types of thermoplastic resins which have a glass transition temperature lower than that of the thermoplastic resin included in the second thermoplastic resin layer 42 and are well known. For example, the first and third thermoplastic resin layers 41 and 43 may each independently include at least one selected from the group consisting of polyethylene, polypropylene, and ethylene vinyl acetate.

According to an implementation, the first thermoplastic resin layer 41 and the third thermoplastic resin layer 43 may include the same type of thermoplastic resin. In this case, the glass transition temperature of the first thermoplastic resin layer 41 may be substantially equal to the glass transition temperature of the third thermoplastic resin layer 43.

According to an implementation, the glass transition temperature of the second thermoplastic resin layer 42 may be between 50° C. and 70° C., or preferably 100° C. or higher. In this case, when the glass transition temperature of the second thermoplastic resin layer 42 satisfies the numerical range, the second thermoplastic resin layer 42 may have very excellent mechanical strength.

According to an implementation, a ratio of the thickness T2 of the second thermoplastic resin layer 42 to the total thickness of the protective member 40 may range from 1:0.25 to 0.65, may range from 1:0.30 to 0.60, may range from 1:0.35 to 0.60, may range from 1:0.40 to 0.58, or may range from 1:0.50 to 0.58. In this case, the total thickness of the protective member may be a value obtained by adding the thicknesses T1, T2, and T3 of each of the first to third thermoplastic resin layers 41, 42, and 43. In some cases, when the thickness T2 of the second thermoplastic resin layer 42 satisfies the numerical range, the second thermoplastic resin layer 42 effectively serves as a support between the solid-state electrolyte layers (e.g., reference numbers 32 and 31 (13)), thereby improving the durability and cycle characteristics of the all-solid-state secondary battery.

According to one implementation, a ratio of the thickness T1 of the first thermoplastic resin layer 41 to the total thickness of the protective member 40, and the ratio of the thickness T3 of the third thermoplastic resin layer 43 to the total thickness of the protective member 40 may independently range from 1:0.15 to 0.40, 1:0.175 to 0.375, or 1:0.20 to 30. In this case, when each of the thickness T1 of the first thermoplastic resin layer 41 and the thickness T3 of the third thermoplastic resin layer 43 independently satisfies the above numerical range, the first and third thermoplastic resin layers 41 and 43 effectively serve as a buffer between the solid-state electrolyte layers (e.g., reference numbers 32 and 31 (L3), thereby improving the durability and cycle characteristics of the all-solid-state secondary battery.

According to an implementation, the cathode layer 20 may include a cathode current collector layer 21 and a pair of cathode active material layers. In this case, the cathode current collector layer 21 may be interposed between the pair of cathode active material layers. For example, as illustrated in FIG. 2, the pair of cathode active material layers may include a cathode active material layer 22 disposed on a bottom surface of the cathode current collector layer 21 and a cathode active material layer 23 disposed on a top surface of the cathode current collector layer 21.

According to an implementation, the anode layer 10 may include an anode current collector layer 11 and a pair of anode active material layers. In this case, the anode current collector layer 11 may be interposed between the pair of anode active material layers. For example, as illustrated in FIG. 2, the pair of anode active material layers may include an anode active material layer 12 disposed on a bottom surface of the anode current collector layer 11 and an anode active material layer 13 disposed on a top surface of the anode current collector layer 11.

Method for Manufacturing all-Solid-State Secondary Battery

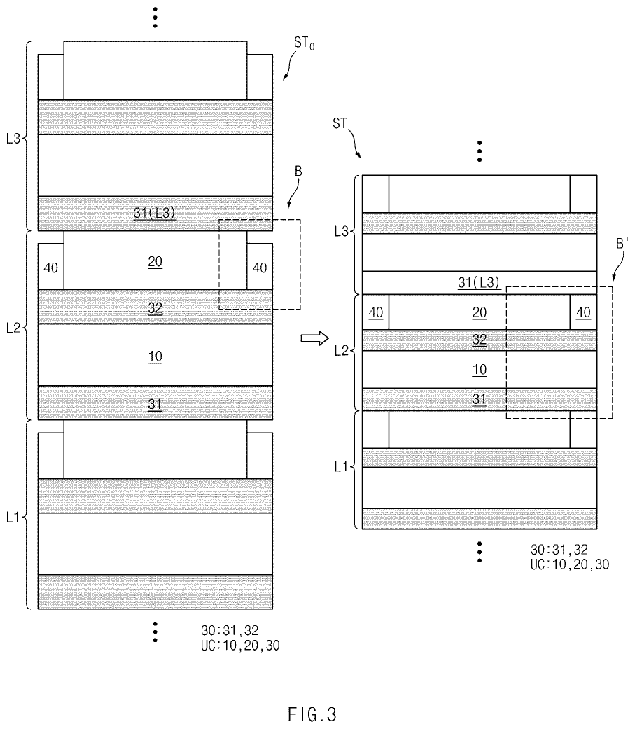

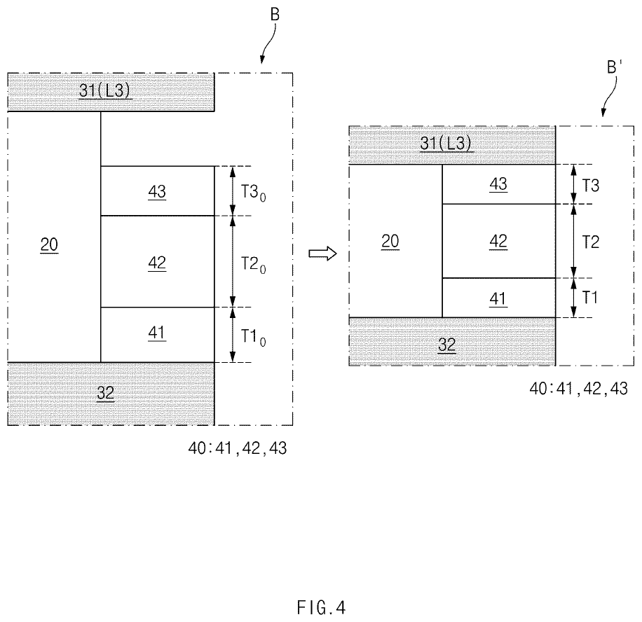

Hereinafter, a method for manufacturing an all-solid-state secondary battery according to the present disclosure will be described with reference to FIGS. 3 and 4.

FIG. 3 is a view illustrating the method for manufacturing the all-solid-state secondary battery, according to an implementation of the present disclosure.

Referring to FIG. 3, the method for manufacturing the all-solid-state secondary battery according to the present disclosure may include forming a cell stack ST by performing a warm pressing process for a preliminary cell stack ST₀ after forming the preliminary cell stack ST₀.

In this case, the cell stack ST may be substantially the same as the cell stack ST described above with reference to FIGS. 1 and 2. Accordingly, the duplication thereof will be omitted.

The preliminary cell stack ST₀ may be a previous cell stack of the cell stack ST before being warm pressed. Accordingly, the preliminary cell stack ST₀ may include substantially the same components as those included in the cell stack ST. For example, the preliminary cell stack ST₀ may have a stack structure in which a plurality of unit cells UC are stacked, and the stack structure may be, for example, a structure including a three-layer structure including a first layer L1, a second layer L2, and a third layer L3, as illustrated in FIG. 3.

Various methods for forming the preliminary cell stack ST₀ may be employed. However, preferably, the protective member is disposed on the peripheral portion, at which the cathode layer 20 is not disposed, on a side surface of the solid-state electrolyte layer 30 having the anode layer 10. As described above, a plurality of unit cells UC at which the protective member is disposed are stacked, thereby forming the preliminary cell stack ST₀. Alternatively, for example, after stacking the plurality of unit cells UC, the protective member 40 may be disposed (or inserted) on the peripheral portion, at which the cathode layer 20 is not disposed, on the side surface of the solid-state electrolyte layer 30 having the anode layer 10.

Accordingly, the protective member 40 in the preliminary cell stack ST₀ may be interposed between two solid-state electrolyte layers (e.g., reference numbers 32 and 31 (L3)) disposed to be adjacent to each other to interpose the cathode layer 20 between the two solid-state electrolyte layers.

Thereafter, the preliminary cell stack ST₀ may be warm pressed in the stack direction in which the unit cells UC included in the preliminary cell stack ST₀ are stacked, thereby forming the cell stack ST.

In this case, each of a plurality of unit cells UC in the preliminary cell stack ST₀ may be pressed in the stack direction. Accordingly, the average thickness of the plurality of unit cells UC in the preliminary cell stack ST₀ may be greater than the average thickness of the plurality of unit cells UC in the cell stack ST.

Similarly, the protective member 40 may be pressed in the stack direction by two solid-state electrolyte layers (e.g., reference numbers 32 and 31 (L3)) disposed to be adjacent to each other to interpose the cathode layer 20 between the solid-state electrolyte layers. Accordingly, the average thickness of the protective member 40 in the preliminary cell stack ST₀ may be greater than the average thickness of the protective member 40 in the cell stack ST.

In some cases, when the preliminary cell stack ST₀ is warm pressed, pressure applied to each of the plurality of unit cells UC included in the preliminary cell stack ST₀ may be different from each other. Accordingly, when the cell stack ST is formed from the preliminary cell stack ST₀, each of the plurality of unit cells UC in the preliminary cell stack ST₀ may be compressed at a random compression rate. In this case, the plurality of unit cells UC in the preliminary cell stack ST₀ may have a substantially equal thickness. Alternatively, the plurality of unit cells UC in the cell stack ST compressed at a random compression ratio may have mutually different thicknesses.

FIG. 4 illustrates an enlarged view of region B and region B′ of FIG. 3. The protective member 40 in the method for manufacturing the all-solid-state secondary battery according to the present disclosure will be described in more detail.

In some cases, the components included in the protective member 40 may be substantially the same as those included in the protective member 40 described with reference to FIG. 2. Hereinafter, the duplication thereof will be omitted to avoid redundancy.

According to an implementation, the glass transition temperature of the second thermoplastic resin layer 42 may be higher than the temperature for performing the warm pressing process, and the glass transition temperature of the first thermoplastic resin layer 41 and the glass transition temperature of the third thermoplastic resin layer 43 may be lower than the temperature for performing the warm pressing process.

In this case, the second thermoplastic resin layer 42 having the higher glass transition temperature during the warm pressing process may serve as a support between the two adjacent solid-state electrolyte layers, and the first and third thermoplastic resin layers 41 and 43 having the lower glass transition temperature may absorb the impact between the two adjacent solid-state electrolyte layers. Accordingly, the reliability for the warm pressing process may be improved.

In addition, in the unit cells UC compressed at a random compression ratio as described above, the protective member including the first to third thermoplastic resin layers 41, 42, and 43 having the glass transition temperatures may absorb the impact between two adjacent solid-state electrolyte layers or may serve as a support between the two adjacent solid-state electrolyte layers to correspond to the random compression ratio.

According to an implementation, the thicknesses T1₀, T2₀, and T3₀ of the first to third thermoplastic resin layers 41, 42, and 43 before the warm pressing process is performed may be greater than the thicknesses T1, T2, and T3 of the first to third thermoplastic resin layers 41, 42, and 43 after the warm pressing process.

According to an implementation, the thickness change rate of the first thermoplastic resin layer 41 before and after the warm pressing process, which is expressed through following Equation 1, and the thickness change rate of the third thermoplastic resin layer 43 before and after the warm pressing process operation, which is expressed through Equation 3 may be greater than the thickness change rate of the second thermoplastic resin layer 42 before and after the warm pressing process operation, respectively, which is illustrated in following Equation 2.

Thickness change rate of first thermoplastic resin layer=(T10−T1)/T10×100[%] [Equation 1]

Thickness change rate of second thermoplastic resin layer=(T2₀−T2)/T2₀×100[%] [Equation 2]

Thickness change rate of second thermoplastic resin layer=T3₀−T3)/T3₀×100[%] [Equation 3]

Hereinafter, the present disclosure will be described in more detail. However, these examples are provided for the convenience of explanation, and the scope of the present disclosure is not limited thereto.

### Example 1: Manufacturing of all-Solid-State Secondary Battery Including Cell Stack and Protective Member

An example preliminary cell stack structure is illustrated in FIG. 3. In this case, the stack structure of the first thermoplastic resin layer (ethylene vinyl acetate; glass transition temperature: −25° C. to 0° C.), the second thermoplastic resin layer (polystyrene, glass transition temperature: 100° C.), and the third thermoplastic resin layer (ethylene vinyl acetate; glass transition temperature: −25 to 0° C.) sequentially stacked were used as the protective member.

Then, the all-solid-state secondary battery having the cell stack structure illustrated in FIGS. 1 to 3 was manufactured by performing the warm processing process (pressure in the warming processing: 300 to 600 Mpa, and the temperature for the warm pressing process is 90° C.) with respect to the stack structure in the stack direction.

In some cases, the anode layer 10, the cathode layer 20, and the solid-state electrolyte layer 30 used for manufacturing for the all-solid-state secondary battery according to Example 1 include materials described in following table 1. In the cell stack structure included in the all-solid-state secondary battery according to Example 1, the thickness of the first thermoplastic resin layer: the thickness of the second thermoplastic resin layer: the thickness of the third thermoplastic resin layer was 25:50:25.

TABLE 1

| | | |
|---|---|---|
| Anode layer | Anode active | Carbon-based active material |
| | material layer | |
| | Anode current | Cu current collector layer |
| | collector layer | |
| Cathode layer | Cathode active | Metal oxide |
| | material layer | |
| | Cathode current | Al current collector layer |
| | collector layer | |

| | |
|---|---|
| Solid-state electrolyte layer | Sulfide-based solid electrolyte |

### Example 2: Manufacturing of all-Solid-State Secondary Battery Including Cell Stack and Protective Member

An all-solid-state secondary battery according to Example 2 was manufactured through the same manufacturing process as that of Example 1, except that the ratio among the thickness of the first thermoplastic resin layer: the thickness of the thickness of the second thermoplastic resin layer: the thickness of the third thermoplastic resin layer included in the protective member of the cell stack in the all-solid-state secondary battery satisfy 40:20:40.

### Example 3: Manufacturing of all-Solid-State Secondary Battery Including Cell Stack and Protective Member

An all-solid-state secondary battery according to Example 3 was manufactured through the same manufacturing process as that of Example 1, except that the ratio among the thickness of the first thermoplastic resin layer: the thickness of the thickness of the second thermoplastic resin layer: the thickness of the third thermoplastic resin layer included in the protective member of the cell stack included in the all-solid-state secondary battery satisfy 15:70:15.

### Comparative Example 1: Manufacturing all-Solid-State Secondary Battery Including Cell Stack and Protective Member

An all-solid-state secondary battery according to Comparative Example 1 was manufactured through the same manufacturing process as that of Example 1, except that a protective member having a single layer structure of the first thermoplastic resin layer (ethylene vinyl acetate; glass transition temperature: −25° C. to 0° C.) was used.

### Experimental Example 1: Evaluation for Reliability of all-Solid-State Secondary Battery

Optical microscope (OM) images of the all-solid-state secondary battery were captured according to Example 1 and the Comparative Example 1, and the results are illustrated in FIGS. and 6.

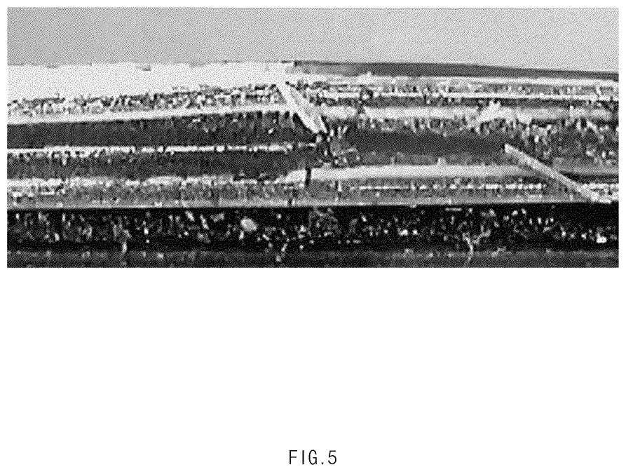

Referring to FIG. 5, it may be recognized that the protective member in the all-solid-state secondary battery according to Example 1 is compressed to correspond to the compression rate of cell stacks compressed at a random compression rate resulting from the warm pressing process.

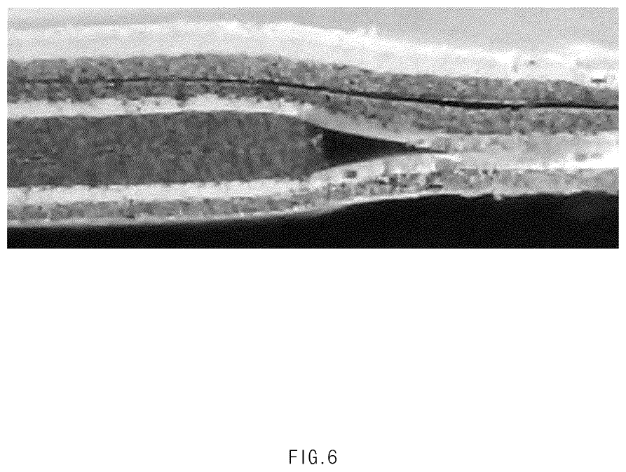

In addition, referring to FIG. 6, it may be recognized that the protective member including only the thermoplastic resin, which has a lower glass transition temperature, of the all-solid-state secondary battery according to Comparative Example 1 is fully lost during the warm pressing process performed at a temperature higher than the glass transition temperature.

### Experimental Example 2: Evaluation for Capacity Retention Characteristic of all-Solid-State Secondary Battery

Charge/discharge cycles were performed several times, with respect to the all-solid-state secondary battery manufactured according to Examples 1 to 3 under the condition of a voltage range of 4.2 V to 2.0 V, the temperature of 50° C., and the rate of 1/3C, respectively.

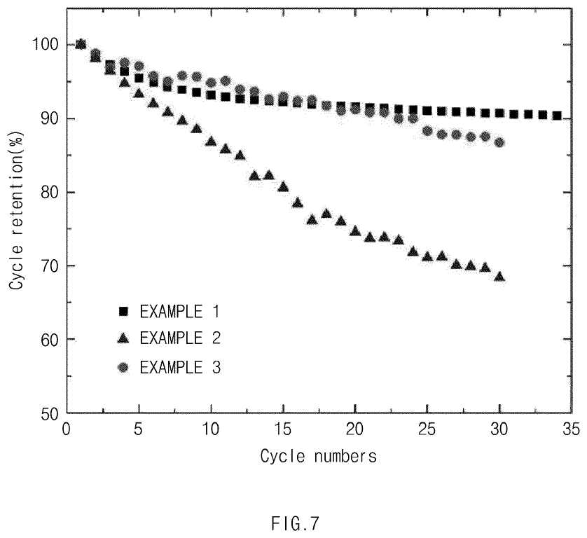

Referring to FIG. 7, it was recognized that the all-solid-state secondary battery according to Examples 1 to 3 has substantially excellent capacity retention characteristics. This is because the protective member is disposed in a space having no cathode layer between two solid-state electrolyte layers adjacent to each other such that the cathode layer is interposed between the two solid-state electrolyte layers, in the all-solid-state secondary battery, and flexibly serves as the buffer member and the support, such that the reliability for the all-solid-state secondary battery is improved.

In some cases, it may be recognized that the all-solid-state secondary battery according to Example 1 shows the greatest capacity retention characteristic, among the all-solid-state secondary batteries according to Examples 1 to 3 This is because the all-solid-state secondary battery according to Example 1 can most effectively performs the function of the buffer member and the function of the support, thereby contributing to the improvement of the reliability of the all-solid-state secondary battery.

### Experimental Example 3: Evaluation for Coulomb Efficiency for all-Solid-State Secondary Battery

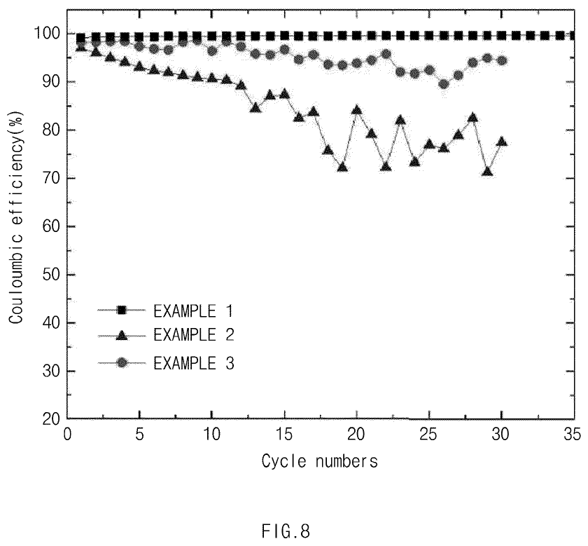

Charge/discharge cycles were performed several times, with respect to the all-solid-state secondary battery manufactured according to Examples 1 to 3 under the condition of a voltage range of 4.2 V to 2.0 V, the temperature of 50° C., and the rate of 1/3C, respectively. The coulomb efficiency of the all-solid-state secondary battery in each cycle was measured, and the result was illustrated in FIG. 8.

Referring to FIG. 8, it was recognized that the all-solid-state secondary battery according to Examples 1 to 3 has substantially excellent coulomb efficiency. This is because the protective member is disposed in a space having no cathode layer between two solid-state electrolyte layers adjacent to each other such that the cathode layer is interposed between the two solid-state electrolyte layers, in the all-solid-state secondary battery, and flexibly serves as the buffer member and the support, such that the reliability for the all-solid-state secondary battery is improved.

In some cases, it may be recognized that the all-solid-state secondary battery according to Example 1 shows the greatest coulomb efficiency, among the all-solid-state secondary batteries according to Examples 1 to 3. This is because the all-solid-state secondary battery according to Example 2 most effectively performs the function of the buffer member and the function of the support, thereby contributing to the improvement of the reliability of the all-solid-state secondary battery.

According to the present disclosure, the all-solid-state secondary battery includes the protective member disposed on the peripheral portion, which has no cathode layer, of the solid-state electrolyte layers, between the two solid-state electrolyte layers disposed to be adjacent to each other such that the cathode layer is interposed between the two solid-state electrolyte layers. In this case, the protective member may compensate for the step difference defined due to the difference in area between the cathode layer and the solid-state electrolyte layers. Accordingly, the solid-state electrolyte layer may not be broken (e.g., cracked) during the manufacturing process such as the warm pressing process.

In some cases, the protective member includes the first thermoplastic resin layer, the second thermoplastic resin layer, and the third thermoplastic resin layer sequentially stacked.

Accordingly, the protective member may have the excellent mechanical strength derived from the second thermoplastic resin layer having the higher glass transition temperature and excellent shock absorption derived from the first thermoplastic resin layer and the third thermoplastic resin layer having the lower glass transition temperature.

Accordingly, the protective member may absorb the impact between the two solid-state electrolyte layers adjacent to each other to correspond to a random compression rate, or may support the two solid-state electrolyte layers, in the unit cells compressed at the random compression rate during the warm pressing process.

Hereinabove, although the present disclosure has been described with reference to exemplary implementations and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An all-solid-state secondary battery comprising:
a cell stack comprising a plurality of unit cells that are stacked, each unit cell including (i) an anode layer, (ii) a pair of solid-state electrolyte layers interposing the anode layer between the solid-state electrolyte layers, and (iii) a cathode layer provided opposite the anode layer such that one solid-state electrolyte layer from the pair of solid-state electrolyte layers is interposed between the anode layer and the cathode layer, wherein an area of the cathode layer that faces the one solid-state electrolyte layer is less than an area of the anode layer that faces the one solid-state electrolyte layer; and
a protective member including (i) a first thermoplastic resin layer, (ii) a second thermoplastic resin layer, and (iii) a third thermoplastic resin layer, wherein the first, second and third thermoplastic resin layers are sequentially stacked, the protective member being interposed between two adjacent solid-state electrolyte layers between which the cathode layer is interposed, the protective member being disposed at a peripheral portion of the solid-state electrolyte layers where the cathode layer is not disposed,
wherein a glass transition temperature of the first thermoplastic resin layer and a glass transition temperature of the third thermoplastic resin layer are lower than a glass transition temperature of the second thermoplastic resin layer.

2. The all-solid-state secondary battery of claim 1, wherein the first thermoplastic resin layer and the third thermoplastic resin layer include the same thermoplastic resin.

3. The all-solid-state secondary battery of claim 1, wherein the glass transition temperature of the second thermoplastic resin layer is 50° C.

4. The all-solid-state secondary battery of claim 1, wherein a ratio of a thickness of the second thermoplastic resin layer to a total thickness of the protective member is 1:0.25 to 0.65.

5. The all-solid-state secondary battery of claim 4, wherein each of a ratio of a thickness of the first thermoplastic resin layer to the total thickness of the protective member, and a ratio of a thickness of the third thermoplastic resin layer to the total thickness of the protective member is 1:0.15 to 0.40.

6. The all-solid-state secondary battery of claim 1, wherein the second thermoplastic resin layer is spaced apart from each of the two solid-state electrolyte layers disposed to be adjacent to each other, such that the cathode layer is interposed between the two solid-state electrolyte layers.

7. The all-solid-state secondary battery of claim 1, wherein each of the first thermoplastic resin layer and the third thermoplastic resin layer includes at least one of polyethylene, polypropylene, or ethylene vinyl acetate.

8. The all-solid-state secondary battery of claim 1, wherein the second thermoplastic resin layer includes at least one of polyvinyl chloride, polystyrene, polymethyl methacrylate, or acrylonitrile butadiene styrene.

9. The all-solid-state secondary battery of claim 1, wherein the cathode layer includes:
a cathode current collector layer; and
a pair of cathode active material layers interposing the cathode current collector layer between the cathode active material layers.

10. The all-solid-state secondary battery of claim 1, wherein the anode layer includes:
an anode current collector layer; and
a pair of anode active material layers interposing the anode current collector layer between the anode active material layers.

11. The all-solid-state secondary battery of claim 1, wherein the plurality of unit cells included in the cell stack have different thicknesses from each other.

12. A method for manufacturing an all-solid-state secondary battery, the method comprising:
forming a preliminary cell stack formed by stacking plurality of unit cells, wherein each unit cell includes:
an anode layer,
a pair of solid-state electrolyte layers interposing the anode layer between the solid-state electrolyte layers, and
a cathode layer provided in opposition to the anode layer such that one solid-state electrolyte layer from among the solid-state electrolyte layers is interposed between the anode layer and the cathode layer, and smaller than the anode layer in an area facing the one solid-state electrolyte layer, and
wherein a protective member is disposed in the unit cell, the protective member including a first thermoplastic resin layer, a second thermoplastic resin layer, and a third thermoplastic resin layer sequentially stacked in a peripheral portion, in which the cathode layer is not disposed, of one solid-state electrolyte layer, and on a side surface of the cathode layer; and
forming a cell stack by performing a warm pressing process for the preliminary cell stack, in a stack direction in which the plurality of unit cells are stacked,
wherein glass transition temperature of the first thermoplastic resin layer and a glass transition temperature of the third thermoplastic resin layer are lower than a glass transition temperature of the second thermoplastic resin layer.

13. The method of claim 12, wherein the glass transition temperature of the second thermoplastic resin layer is higher than a temperature for the warm pressing process, and
wherein the glass transition temperature of the first thermoplastic resin layer and the glass transition temperature of the third thermoplastic resin layer are lower than the temperature for the warm pressing process.

14. The method of claim 12, wherein the protective member is interposed between two solid-state electrolyte layers disposed to be adjacent to each other such that the cathode layer is interposed between the two solid-state electrolyte layers, in the preliminary cell stack.

15. The method of claim 14, wherein the protective member is pressed in the stack direction by the two solid-state electrolyte layers, during the warm pressing process.

16. The method of claim 12, wherein an average thickness of the plurality of unit cells in the preliminary cell stack is greater than an average thickness of the plurality of unit cells in the cell stack.

17. The method of claim 12, wherein the plurality of unit cells have an equal thickness in the preliminary cell stack.

18. The method of claim 12, wherein the plurality of unit cells in the cell stack have mutually different thicknesses.

19. The method of claim 12, wherein a ratio of a thickness of the second thermoplastic resin layer to a total thickness of the protective member is 1:0.25 to 0.65 in the cell stack.

20. The method of claim 19, wherein each of a ratio of a thickness of the first thermoplastic resin layer to the total thickness of the protective member, and a ratio of a thickness of the third thermoplastic resin layer to the total thickness of the protective member is 1:0.15 to 0.40 in the cell stack.
